(19) United States
(12) Patent Application Publication
(10) Pub. No.: US 2009/0007806 A1
(43) Pub. Date: Jan. 8, 2009

(54) FUNCTIONAL UNIT FOR A ROTARY PRINTING PRESS AND ROTARY PRINTING PRESS WITH SUCH A FUNCTIONAL UNIT

(75) Inventors: Johannes BEHMEL, Plauen (DE); Stephan PATZELT, Plauen (DE); Silvio SCHMALFUSS, Hohenleuben (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/167,887

(22) Filed: Jul. 3, 2008

(30) Foreign Application Priority Data
Jul. 4, 2007 (DE) 10 2007 031 012.0

(51) Int. Cl. B41F 5/00

(52) U.S. Cl. 101/216

(57) ABSTRACT

A functional unit for a rotary printing press and a rotary printing press having such a functional unit is disclosed. The functional unit has an assembly unit to receive at least one component of the functional unit, in which the assembly unit has at least one assembly section, at least one assembly opening that is formed in the assembly section and in which the at least one component is received, and a support section on which a weight load is supportable. A component-free opening that in one cross-sectional dimension is at least as large as one cross-sectional dimension of the assembly opening is provided in the assembly section between the support section and the at least one assembly opening. Pre-stresses induced by the weight load on a bearing element are thereby inexpensively reduced or avoided for the component.

This application claims the priority of German Patent Document No. 10 2007 031 012.0, filed Jul. 4, 2007, the disclosure of which is expressly incorporated by reference herein.

### BACKGROUND AND SUMMARY OF THE INVENTION

The invention relates to a rotary printing press and in particular a functional unit for a rotary printing press, as well as a rotary printing press equipped with such a functional unit, in which, as a result of constant and defined assembly conditions in the functional unit, improved operating conditions and therefore increased useful life of the functional unit are achieved.

In the area of rotary printing press construction, particularly web-fed rotary printing press construction, it is customary, for technological reasons or for reasons of optimum utilization of space, to pile components or functional units of a rotary printing press, such as printing units or folders, above each other or to arrange them in a stack.

Examples of such stacked arrangement of the functional units of the rotary printing press (hereinafter simply printing press) are the “REGIOMAN” and “GEOMAN” printing presses manufactured by MAN Roland Druckmaschinen AG. In these printing presses, two eight-cylinder printing units or H-printing units (rubber-rubber) are piled on each other to form a printer tower, as a result of which, for example, a so-called 4/4 color print (the application of four colors on each side of a paper web to be printed) can be achieved with short web paths.

As a result of this stacked arrangement of the functional units (such as printing units), the respective lower functional units must support or receive the weight load of the upper functional units that are disposed on them. This can cause the assembly openings produced in the functional units, such as, for example, in printing units the bore holes to receive the cylinder bearings, to deform and consequently lead to radial pre-stressing of the bearing element mounted therein, such as a ball bearing and/or a roller bearing.

The radial pre-stressing of the bearing element can lead to an overload and even to its premature failure.

The aforementioned deformation problem has been further exacerbated because the developmental trend for printing presses has recently been in the direction of integrating increasing numbers of print positions into one printing unit, as a result of which the printing units receive a higher weight.

To remedy this problem, it is currently common for some printing press manufacturers not to make the assembly openings (such as the cylinder bearing holes in the printing units) in them until after the relevant functional units are piled on each other. As a result, an assembly opening that is to a certain extent free of deformation is obtained, but the complexity of manufacturing and assembling the printing press is drastically increased.

The aim of the invention is to provide a functional unit for a rotary printing press and a rotary printing press having such a functional unit, in which, in the functional unit, the pre-stresses that are induced by the weight load on bearing elements are inexpensively reduced or avoided for their components.

In accordance with the invention, a functional unit for a rotary printing press has an assembly unit for receiving at least one component of the functional unit. The assembly unit has at least one assembly section having a pre-specified thickness, at least one assembly opening, in which the assembly section is formed and in which the at least one component is received by means of a bearing element, and a support section on which a weight load is supportable.

A first component-free opening that in one cross-sectional dimension is at least as large as a cross-sectional dimension of the assembly opening is provided in the assembly section between the support section and the at least one assembly opening.

In accordance with the invention, it was recognized by means of a computer-supported finite element analysis (FE analysis) that by deliberately providing a component-free opening or relief opening in the assembly section, forces induced by the weight load, which can lead to deformation of the assembly opening, can be diverted to adjacent sections of the assembly unit.

In that way, deformations of the assembly opening are substantially reduced or avoided, as a result of which constant and defined installation and operating conditions for the bearing element of the component are created. In other words, no or only slight radial pre-stresses are applied to the bearing element, so that reliable operation or the full useful life of the bearing element is achieved.

Consequently, it is possible using the configuration of the assembly unit in accordance with the invention to make the assembly opening already at the time of production of the individual functional unit. In other words, in accordance with the invention it is possible to avoid not making the assembly openings until in assembly condition, during which the functional units are piled on each other or stacked.

The term “component-free opening” is to be understood within the framework of the invention to mean that there is no need for such an opening in reference to the fully functional assembly of the functional unit, such as for example the bearing of components, the routing through of cables, tubes, and shafts or axes, etc., but instead that such an opening is provided in addition to the functionally necessary openings, such as the assembly openings, to protect the assembly openings from deformation forces or to divert the deformation forces.

In accordance with a further development of the invention, the assembly opening is designed as a through-hole running through the thickness of the assembly section.

In accordance with another further development of the invention, the first component-free opening is designed as a through-hole running through the thickness of the assembly section.

With that configuration of the invention, the diversion of the deformation forces induced by the weight load is further improved, particularly when the assembly opening is designed as a through-hole.

In accordance with a further development of the invention, the component-free opening is disposed in front of the assembly opening in a main direction of action of the weight load in reference to the assembly opening.

With this configuration, any weight forces induced by the weight load are even better diverted from the assembly opening to adjacent sections of the assembly unit, since the component-free opening or the relief section is disposed in an optimal position in front of the assembly opening.

In accordance with a further development of the invention, the first component-free opening is designed as a slot having a pre-specified width and a pre-specified length.

With that configuration, it is possible, in a particularly advantageous manner, i.e., without major material wear and easily feasible in terms of production engineering, to design a cross-sectional dimension of the component-free opening that is at least as large as a cross-sectional dimension of the assembly opening. In other words, with this configuration the length of the slot is chosen in such a way that it is, for example, as large as or larger than a width or a diameter of the assembly opening. In this manner, the entire area of the assembly opening is securely protected from the deformation forces in the direction of action of the weight load or the deformation forces. The width of the slot can vary depending on the weight load being applied, the capabilities of production engineering, and/or the configuration of the assembly unit or be chosen as a function of them.

In that connection, it must be noted that the component-free opening can naturally also be designed as a circular opening, such as, for example, a bore hole. It is important in that connection only that one cross-sectional dimension (in this case the diameter) of the component-free opening is at least as large as one cross-sectional dimension (such as, for example, the diameter in the case of a bore hole) of the assembly opening. In other words, the component-free opening completely covers an area of the assembly opening that is defined by its cross-sectional dimension, so that the assembly opening is protected from the action of the weight load.

In accordance with a further development of the invention, the first component-free opening designed as a slot extends along its length in linear fashion, at least sectionally.

This is particularly advantageous from the viewpoint of production engineering and function. In other words, the slot can, depending on the shape of the assembly unit and the assembly opening, for example, be formed by a single linear section, by multiple linear sections that are optionally disposed at an angle to each other, or by a combination of, for example, curved and linear sections.

It is naturally also possible to design the slot with only one or with only a multiplicity of curved sections.

In accordance with a further embodiment of the invention, the first component-free opening that is designed as a slot extends along its length obliquely to the main direction of action of the weight load, at least in one section.

With this configuration, optimal protection of the assembly opening or diversion of the deformation forces is advantageously achieved. In other words, the slot can, depending on the design of the assembly unit and the assembly unit and weight load, extend obliquely to the main direction of action completely along its length or can extend obliquely to the main direction of action with only one part of its length and extend with the remainder of its length in another direction.

In accordance with a particularly advantageous further development of the invention, a second component-free opening that in one cross-sectional dimension is at least as large as one cross-sectional dimension of the assembly opening is provided on one side of the at least one assembly opening opposite to the first component-free opening.

In other words, in accordance with this configuration of the invention, a component-free opening or a relief section can be provided above and below the assembly opening, with the precise location of the two relief sections being dependent on the design of the assembly unit.

In this configuration of the invention, it is advantageously avoided that the deformation forces induced by the weight load have a retroactive effect on the assembly opening in the form of reaction forces. Even less deformation of the assembly opening is thereby achieved or deformation of it is completely avoided.

In accordance with a further development of the invention, the second component-free opening is designed as a through-hole running through the thickness of the assembly section.

With this configuration of the invention, the diversion of the deformation forces or reaction forces induced by the weight load is further improved, particularly when the assembly opening is designed as a through-hole.

In accordance with another further development of the invention, the second component-free opening is designed as a slot having a pre-specified width and a pre-specified length.

With that configuration, it is possible, in a particularly advantageous manner, i.e., without major material wear and easily feasible in terms of production engineering, to design one cross-sectional dimension of the second component-free opening that is at least as large as one cross-sectional dimension of the assembly opening. In other words, with this configuration the length of the slot is chosen in such a way that it is, for example, as large as or larger than a width or a diameter of the assembly opening. In this manner, the entire area of the assembly opening is securely protected from the deformation forces in the direction of action of the weight load or the deformation forces. The width of the slot can vary depending on the weight load being applied, the capabilities of production engineering, and/or the configuration of the assembly unit or be chosen as a function of them.

In that connection, it must be noted that the second component-free opening can naturally also be designed as a circular opening, such as, for example, a bore hole. It is important in that connection only that one cross-sectional dimension (in this case the diameter) of the component-free opening is at least as large as one cross-sectional dimension (such as, for example, the diameter in the case of a bore hole) of the assembly opening. In other words, the second component-free opening completely covers an area of the assembly opening that is defined by its cross-sectional dimension, so that the assembly opening is protected from the action of the weight load or the reaction forces.

In accordance with a further development of the invention, the first component-free opening designed as a slot extends along its length in linear fashion, at least sectionally.

This is particularly advantageous from the viewpoint of production engineering and function. In other words, the slot can, depending on the shape of the assembly unit and the assembly opening, for example, be formed by a single linear section, by multiple linear sections that are optionally disposed at an angle to each other, or by a combination of, for example, curved and linear sections.

It is naturally also possible to design the slot with only one or with only a multiplicity of curved sections.

In accordance with a further embodiment of the invention, the first component-free opening that is designed as a slot extends along its length obliquely to the main direction of action of the weight load, at least in one section.

With this configuration, even better protection of the assembly opening or diversion of the deformation or reaction forces is advantageously achieved. In other words, the slot can, depending on the design of the assembly unit and the assembly unit and weight load, extend obliquely to the main direction of action completely along its length or can extend obliquely to the main direction of action with only one part of its length and extend with the remainder of its length in another direction.

In accordance with a further development of the invention, the second component-free opening is designed to be doubly mirror-inversed to the first component-free opening.

In other words, the second component-free opening is designed to be mirrored to the first component-free opening over two mirror axes disposed perpendicular to each other.

As a result of this arrangement of the first and second component-free opening, the assembly opening is protected even more effectively from deformation forces, since the assembly opening is quasi or approximately surrounded by the first and the second component-free opening.

In accordance with a further development of the invention, the at least one assembly opening is designed as a circular opening having a pre-specified diameter.

In accordance with that configuration of the invention, the assembly opening can for example be designed as a bore hole or as a preformed circular opening (for example as a cast opening in a cast part), with the cross-sectional dimension of the assembly opening being formed by its diameter.

In other words, in accordance with the invention one cross-sectional dimension of the first and optionally the second component-free opening is at least at large as the diameter of the assembly opening, i.e., equal to it or larger than it.

In accordance with a further development of the invention, the assembly unit has at least two assembly unit elements.

In accordance with a further development of the invention, at least one assembly opening is formed in each of the assembly unit elements.

In accordance with a further development of the invention, the functional unit is a printing unit.

In this connection, it must be mentioned that the functional unit naturally is not limited to a printing unit, such as for example an H-printing unit, and instead can also be a folder, a roll changer, or a dryer.

In accordance with a further development of the invention, the assembly unit elements are designed as lateral walls of the printing unit.

In other words, the assembly unit elements form the lateral wall of the operating side of the printing unit and the lateral wall of the drive side of the printing unit.

In accordance with a further development of the invention, the at least one component is a cylinder of the printing unit, which is rotatably borne by means of respective bearing elements (such as roller bearings and/or ball bearings) in two opposite assembly openings of the two lateral walls of the printing unit.

The cylinder can, for example, be a plate cylinder, a rubber blanket cylinder, and/or a counter-pressure cylinder of the printing unit.

In this connection it must be noted that in advantageous use of the teaching in accordance with the invention, the assembly openings of all cylinders or parts of the printing unit that are rotatably borne in the lateral walls can preferably be provided in accordance with the invention with component-free openings or relief sections.

It must also be noted that, if the component-free openings or relief sections are designed as through-holes, those openings are preferably sealed or filled with a flexible and oil-resistant sealing compound, such as nitrile rubber, so that no dirt can enter the functional unit and no medium, such as lubricating oil, can escape from the functional unit.

The invention is explained below based on preferred embodiments and described in greater detail in reference to the attached figures.

### BRIEF DESCRIPTION OF THE DRAWINGS

FIG. 1A shows a front view of a finite element analysis (FE analysis) of an assembly unit having a multiplicity of assembly openings in accordance with an initial condition, with the assembly unit being deformed by a weight load applied to the support section.

FIG. 1B shows a view similar to FIG. 1A but in which, to show the deformation of the assembly openings, they are outlined in black.

FIG. 1C shows a detail from FIG. 1B in which the assembly section of the assembly unit is shown after enlargement.

FIG. 1D shows a view similar to FIG. 1C but in which, for better visibility of the deformation of the assembly openings, the structure of the FE analysis is omitted.

FIG. 2A shows in a front view an FE analysis of an assembly unit having a multiplicity of assembly openings in accordance with a first embodiment of the invention, with the assembly unit being loaded with the weight load in the same manner as in FIG. 1A.

FIG. 2B shows a view similar to FIG. 2A but in which, for better visibility of the shape of the assembly openings, they are outlined in black.

FIG. 2C shows a detail from FIG. 2B, in which the assembly section of the assembly unit is enlarged.

FIG. 2D shows a view similar to FIG. 2C, but in which, for better visibility of the shape of the assembly openings, the structure of the FE analysis is omitted.

FIG. 3A shows in a front view an FE analysis of an assembly unit having a multiplicity of assembly openings in accordance with a second embodiment of the invention, with the assembly unit being loaded with the weight load in the same way as in FIG. 1A.

FIG. 3B shows a view similar to FIG. 3A, but in which, for better visibility of the shape of the assembly openings, they are outlined in black.

FIG. 3C shows a detail from FIG. 3B in which the assembly section of the assembly unit is enlarged.

FIG. 3D shows a view similar to FIG. 3C, but in which, for better visibility of the shape of the assembly openings, the structure of the FE analysis is omitted.

FIG. 4A shows a front view of an FE analysis of an assembly unit having a multiplicity of assembly openings in accordance with a third embodiment of the invention, with the assembly unit being loaded with the weight load in similar fashion to FIG. 1A.

FIG. 4B shows a view similar to FIG. 4A, but in which, for better visibility of the shape of the assembly openings, they are outlined in black.

FIG. 4C shows a detail from FIG. 4B, in which the assembly section of the assembly unit is enlarged.

FIG. 4D shows a section similar to FIG. 4C, but in which, for better visibility of the shape of the assembly openings, the structure of the FE analysis is omitted.

### DETAILED DESCRIPTION OF THE DRAWINGS

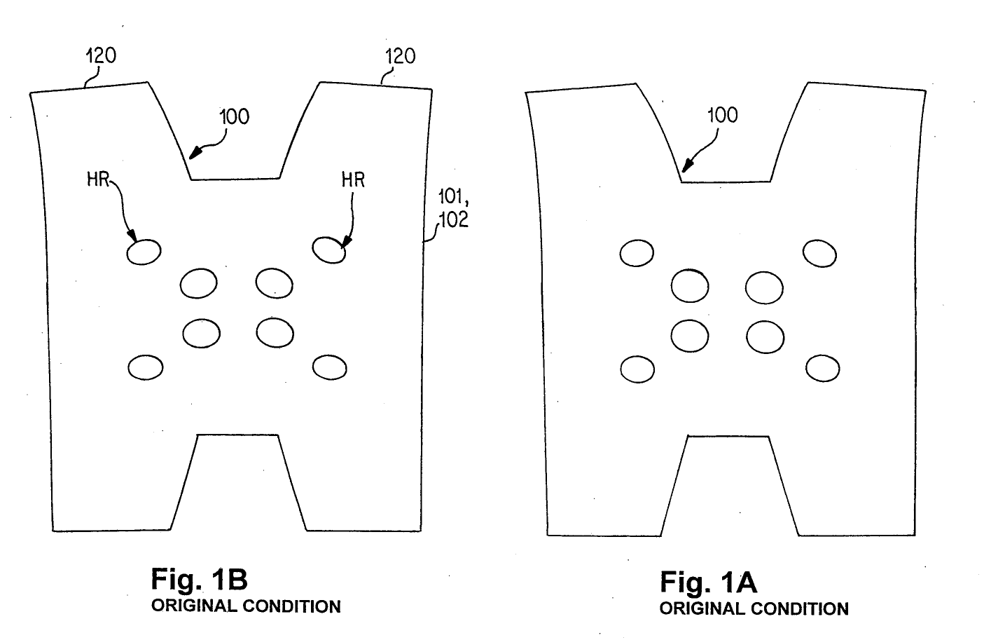

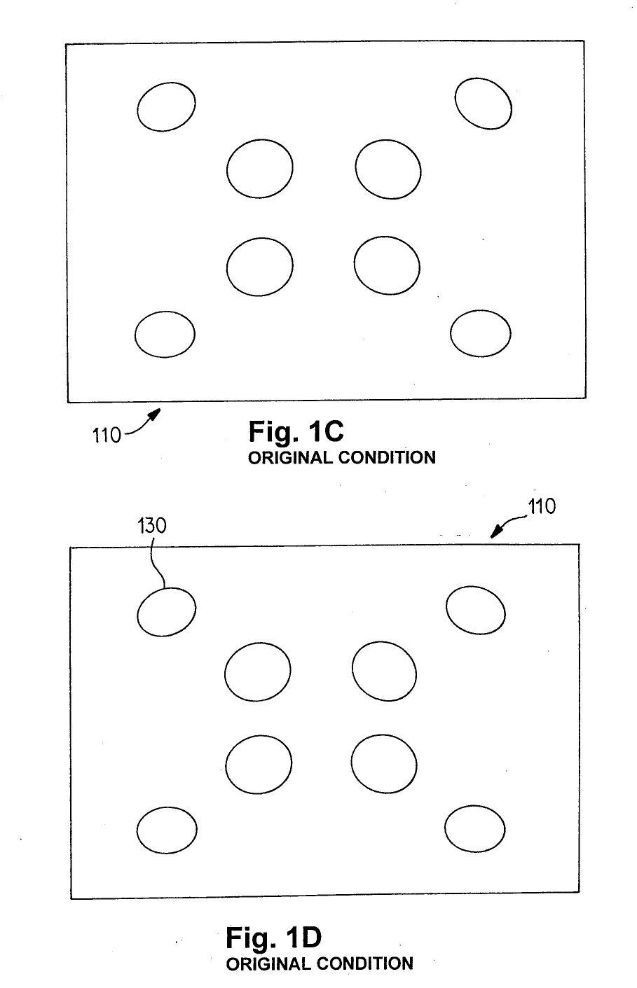

In reference to FIGS. 1A through 1D, an assembly unit 100 of a functional unit (not completely shown and not labeled) for a rotary printing press is shown. In the illustrated case, the functional unit is a so-called H-printing unit (hereinafter simply printing unit) for a web-fed rotary printing press. Assembly unit 100 is in this case base frame 100 of the printing unit, on which the components of the printing unit, such as the plate cylinder, rubber-towel cylinder, inking system, dampening system, drives, and control technology, etc., are to be received or mounted.

As is common in such printing units, the assembly unit or base frame 100 has at least two assembly unit elements, specifically in this case both lateral walls 101 (operating side SI) and 102 (drive side SII) of the printing unit, which lateral walls 101, 102 in the case shown in FIGS. 1A through 1D are designed in accordance with an initial condition underlying the FE analysis. In this connection it must be noted that only lateral wall 101 or 102 of the printing unit is shown in FIGS. 1A through 1D.

Base frame 100 has at least one assembly section 110 having a pre-specified thickness. In other words, in this case each lateral wall 101, 102 of base frame 100 of the printing unit has an assembly section 110 in which a multiplicity of assembly openings are formed. One bearing element by means of which the components are received or borne on lateral walls 101, 102, such as, for example, a ball bearing or a roller bearing, is to be mounted in the assembly openings. In this case, the assembly openings are designed as circular through-holes 130 of pre-specified diameter penetrating through the thickness of assembly section 110 and are used to receive the cylinder bearing of the printing unit.

Base frame 100 of the printing unit also has a support section 120 on which a weight load is supportable. In other words, lateral walls 101, 102 of base frame 100 have on their respective upper side a machined surface on which a second printing unit (as in the “REGIOMAN” or “GEOMAN” printing presses by MAN Roland Druckmaschinen AG which are described above) can be placed.

For the computer-supported FE analysis underlying FIGS. 1A through 1D, a weight load of 25 metric tons, for example, was applied to support section 120. In addition, lateral wall 101 or 102 was assumed for the FE analysis to be a smooth lateral wall without ribbing.

Based on the FE analysis, it was discovered that the weight load in the individual areas of lateral walls 101, 102 exhibits different effects or leads to different deformations.

In accordance with the case shown in FIGS. 1A through 1D, the weight load in the upper left corner of FIGS. 1A and 1B and the upper right corner of lateral wall 101 or 102 leads to a deformation of approximately 0.019 mm to approximately 0.0253 mm (rising from the bottom to the top). In a center section of lateral wall 101, 102 in which through-holes 130 are located in this case, the weight load leads, rising from the bottom to the top, to a deformation of approximately 0.00633 mm to approximately 0.019 mm. In a lower section of lateral wall 101, 102, the weight load leads, rising from the bottom to the top, to a deformation of approximately 0.00127 mm to approximately 0.00633 mm.

In other words, through-holes 130 in the presented case experience with an applied weight load of 25 metric tons a deformation of approximately 0.00633 mm to approximately 0.019 mm. This means that at a higher weight load, which is common in the described printing units and which will further increase as a result of the current trend toward compact printing units with increasing numbers of print positions, a relatively strong deformation of through-holes 130 (here the bearing holes for the cylinder of the printing unit) occurs. This can generate radial pre-stresses in the cylinder bearings received in through-holes 130, which can lead to premature failure of the cylinder bearing.

As shown by arrow HR in FIG. 1B, the weight load in reference to the assembly openings or through-holes 130 exhibits a main direction of action in which the greatest deformation of through-holes 130 occurs. Depending on the configuration of lateral wall 101, 102, on which, for example, ribbing can be provided, the main direction of action HR of the weight load can naturally run otherwise than in the presented case.

As can be seen in particular in FIGS. 1C and 1D, through-holes 130 are deformed in their original cross section of a circle to an ellipse by the deformation forces induced by the weight load.

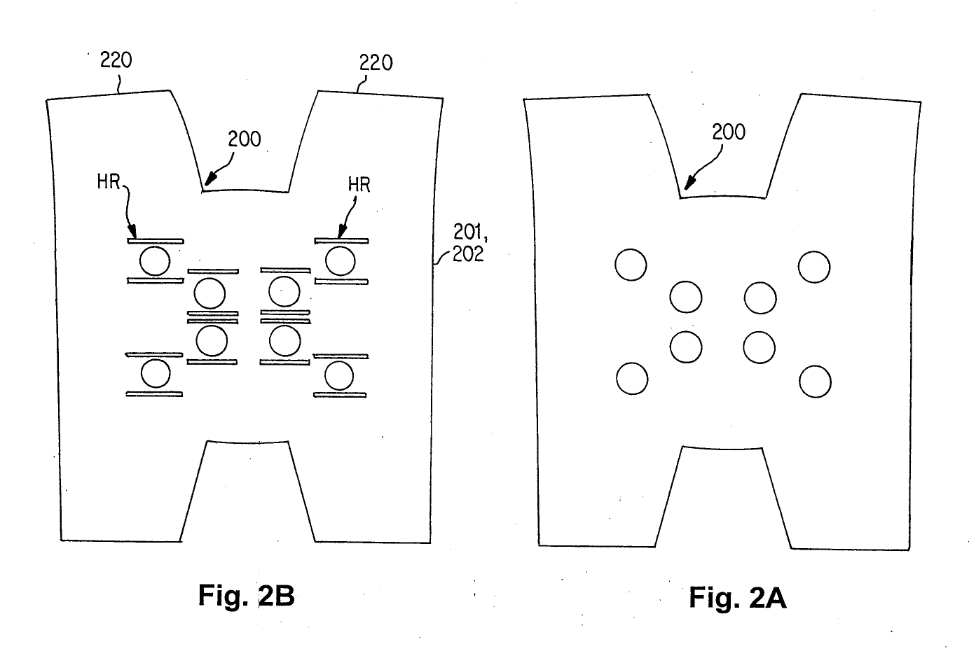

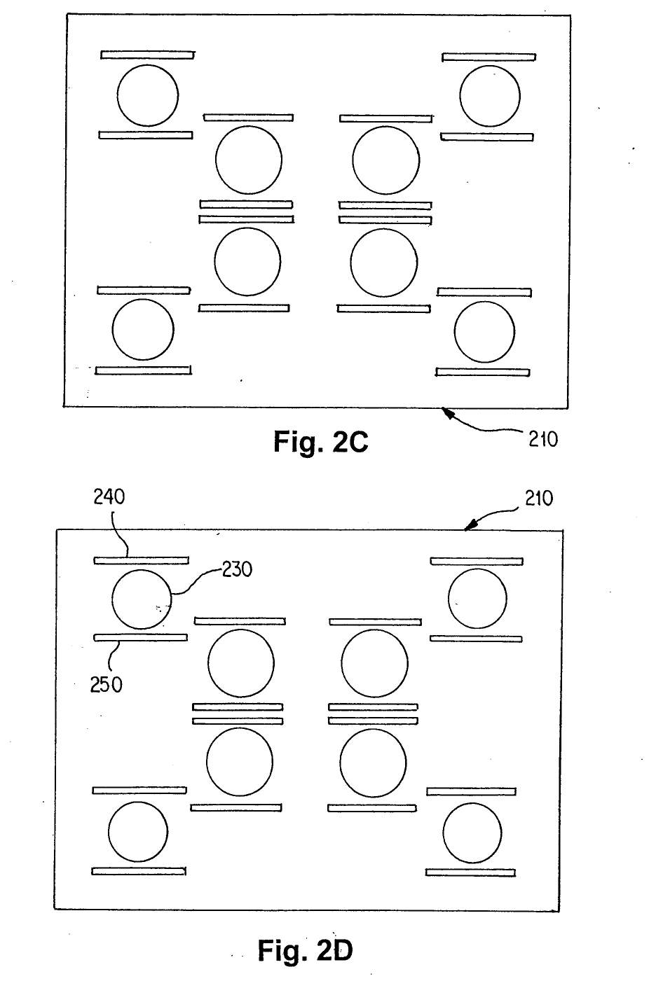

Now a first embodiment of the invention is described in reference to FIGS. 2A through 2D. Assembly unit 200 of the functional unit (not completely shown and not labeled) shown in FIGS. 2A to 2D substantially corresponds to the one shown in FIGS. 1A through 1B.

This means that, in accordance with this first embodiment of the invention, the functional unit is a so-called H printing unit (hereinafter simply printing unit) for a web-fed rotary printing press, and the assembly unit is base frame 200 of the printing unit, with base frame 200 having at least two assembly unit elements, which in accordance with this embodiment of the invention are the two lateral walls 201 (operating side SI) and 202 (drive side SII) of the printing unit. Here, too, only lateral wall 201 or 202 of the printing unit is shown in FIGS. 2A through 2D.

Base frame 200 has at least one assembly section 210 having a pre-specified thickness. In other words, in accordance with the first embodiment of the invention, each lateral wall 201, 202 of base frame 200 of the printing unit has an assembly section 210 in which a multiplicity of assembly openings are formed. One bearing element, by means of which the components are received or borne on lateral walls 201, 202, is to be mounted in each of the assembly openings. In accordance with the first embodiment, the assembly openings are designed as circular through-holes 230 of pre-specified diameter penetrating through the thickness of assembly section 210 and are used to receive the cylinder bearing of the printing unit.

Contrary to the initial condition shown in FIGS. 1A through 1B, in accordance with the first embodiment of the invention, a first component-free opening 240 that in one cross-sectional dimension is at least as large as the diameter of the relevant through-hole 230 is also respectively provided in assembly section 210 between support section 220 and each through-hole 230. Moreover, in accordance with the first embodiment of the invention, a respective second component-free opening 250 that in one cross-sectional dimension is at least as large as the diameter of relevant through-hole 230 is provided in assembly section 210 on one side of respective through-hole 230 opposite respective first component-free opening 240.

As shown in FIGS. 2A through 2D, the first and the second component-free openings are each designed as slot 240 or 250 running through the thickness of assembly section 210 having a cross-section of a pre-specified width and a pre-specified length.

The length of slot 240, 250 that is allocated to a through-hole 230 is at least as large as the diameter of relevant through-hole 230. As shown in FIGS. 2A through 2D, in accordance with this first embodiment of the invention the length of slots 240, 250 is greater than the diameter of relevant through-hole 230.

The width of the slot in accordance with this embodiment of the invention is 10 mm.

In other words, in accordance with this first embodiment relief cuts or slots 240, 250 are made in lateral walls 201, 202 of the printing unit above and below the cylinder holes or through-holes 230.

In accordance with this embodiment, slots 240, 250 extend along their length in linear fashion and horizontally. Moreover, slots 240, 250 are filled with an elastic and oil-resistant compound, such as nitrile rubber, in order to avoid the penetration of dirt and the escape of oil, for example.

Base frame 200 of the printing unit also has a support section 220 on which a weight load is supportable. In other words, lateral walls 201, 202 of base frame 200 have on their respective upper side a machined surface on which a second printing unit (as in the case of the “REGIOMAN” or “GEOMAN” printing press by MAN Roland Druckmaschinen AG which is described above) can be placed.

For the FE analysis underlying FIGS. 2A through 2D, a weight load of 25 metric tons was applied to support section 220 in the same way as in FIGS. 1A through 1D. In addition, lateral wall 201 or 202 was again assumed for the FE analysis to be a smooth lateral wall without ribbing.

As can be seen in FIGS. 2A through 2D, the weight load also leads to deformations in lateral wall 201 or 202 in this case, with the deformations approximately corresponding to those described in reference to FIGS. 1A through 1D.

As can be seen in particular in FIG. 2C and FIG. 2D, however, since a slot 240 is provided between support section 220 and each through-hole 230, whose length is at least as large as the diameter of relevant through-hole 230, through-holes 230 are protected from the deformation forces induced by the weight load or the deformation forces are diverted to adjacent sections of lateral wall 201 or 202, so that through-holes 230 are not deformed or are only minimally deformed and retain their original circular shape.

Since one slot 250, whose length is at least as large as the diameter of the relevant through-hole 230, is also provided (second component-free openings) on the side of the respective through-holes 230 opposite slots 240 (first component-free openings), through-holes 230 are also reliably protected from deformation forces or reaction forces acting on them from the other side or from below.

As shown by arrow HR in FIG. 2B, the weight load in reference to through-holes 230 also exhibits a main direction of action in which the greatest deformation forces would act on through-holes 230. Depending on the configuration of lateral wall 201, 202, on which for example ribbing can be provided, the main direction of action HR of the weight load can naturally run otherwise than in the illustrated case.

As also shown in FIG. 2B, in accordance with the invention slots 240 are disposed in front of through-holes 230 in the main direction of action HR of the weight load in reference to individual through-holes 230, as a result of which through-holes 230 are particularly well or efficiently protected from the deformation forces.

Consequently, it is possible using the configuration in accordance with the invention of lateral walls 201, 202 already to place the cylinder holes or through-holes 230 during production of the individual printing unit. In other words, in accordance with the invention there is no need to place through-holes 230 only in an assembly condition in which the printing units are piled on each other or stacked.

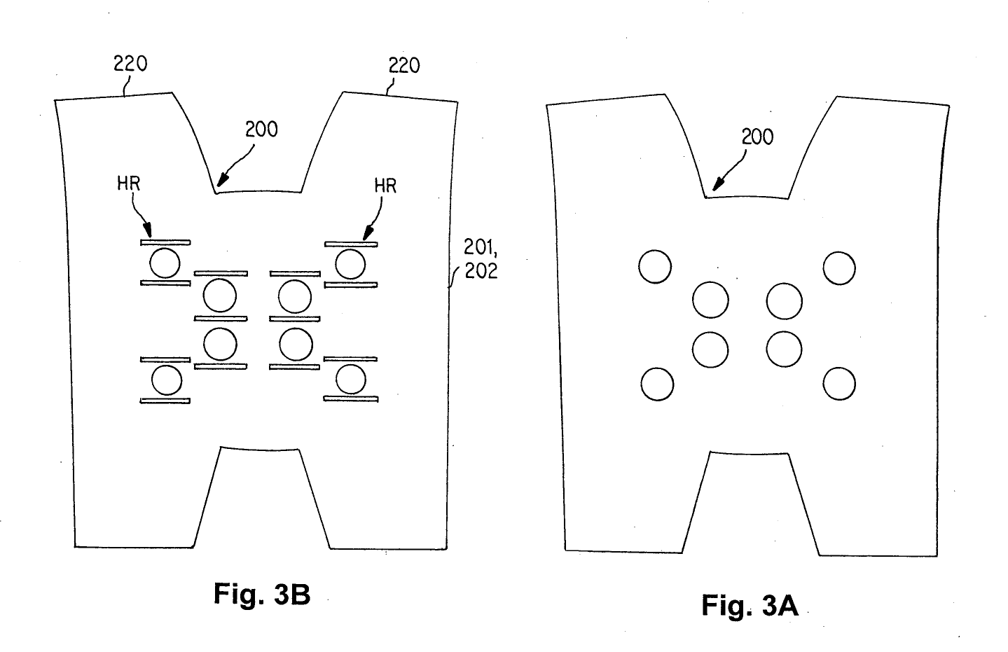

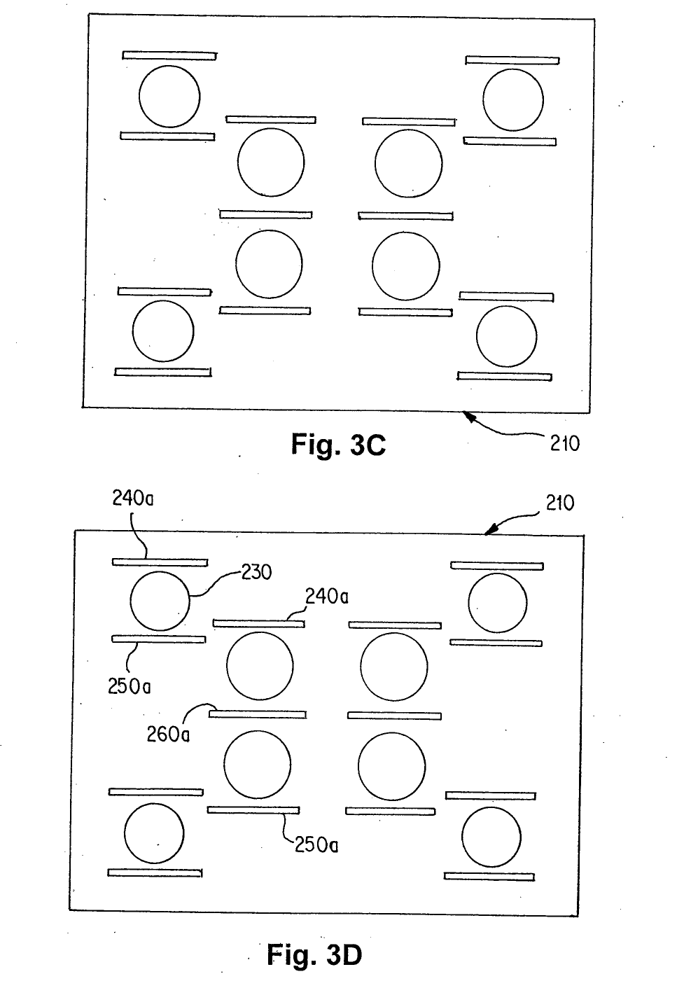

FIGS. 3A through 3D show a second embodiment of the invention which, with the exception of the configuration of the component-free openings, is identical to the first embodiment of the invention. Therefore, only the component-free openings are described in detail below, and the same reference numbers as in the first embodiment are used for identical elements.

For the FE analysis underlying FIGS. 3A through 3D, a weight load of 25 metric tons was applied to support section 220 in a similar manner to FIGS. 1A through 1D and 2A through 2D. In addition, lateral wall 201 or 202 was again assumed for the FE analysis to be a smooth lateral wall without ribbing.

As can best be seen in FIG. 3D, in accordance with the second embodiment of the invention a slot 240a or 260a (first component-free opening) that runs in linear fashion and horizontally through the thickness of assembly section 210, whose length is greater than the diameter of relevant through-hole 230, is provided in assembly section 210 between support section 220 and each through-hole 230. Moreover, in accordance with the second embodiment of the invention, a slot 250a or 260a (second component-free opening) that runs in linear fashion and horizontally through the thickness of assembly section 210, whose length is greater than the diameter of relevant through-hole 230, is provided in assembly section 210 on the side of respective through-hole 230 opposite slot 240a.

Contrary to the first embodiment of the invention, however, there is always only one slot 260a provided between two through-holes 230 disposed one beneath the other in the vertical direction and adjacently. In other words, in accordance with the second embodiment, in this case a slot 260a disposed in this way between two through-holes 230 assumes the function of both the first component-free opening (for respective lower through-hole 230) and the second component-free opening (for respective upper through-hole 230).

In accordance with this embodiment of the invention, the width of the slots is 11 mm.

As can be seen in FIGS. 3A through 3D, the weight load also leads to deformations in lateral wall 201 or 202 in this case, with the deformations approximately corresponding to those described in reference to FIGS. 1A through 1D.

As can be seen in particular in FIG. 3C and FIG. 3D, however, since a slot 240a or 260a whose length is at least as large as the diameter of relevant through-hole 230 is provided between support section 220 and each through-hole 230, through-holes 230 are protected from the deformation forces induced by the weight load or the deformation forces are diverted to adjacent sections of lateral wall 201 or 202, so that through-holes 230 are not deformed or are only minimally deformed and retain their original circular shape.

Since in addition one slot 250a or 260a (second component-free openings) whose length is at least as large as the diameter of the relevant through-hole 230, is provided on the side of respective through-holes 230 opposite slots 240a or 260a (first component-free openings), through-holes 230 are also reliably protected from deformation forces or reaction forces acting on them from the other side or from below.

As shown by arrow HR in FIG. 3B, in this case too the weight load exhibits a main direction of action in reference to through-holes 230, in which the greatest deformation forces would act on through-holes 230. Depending on the configuration of lateral wall 201, 202, on which for example ribbing could be provided, the main direction of action HR of the weight load naturally could run otherwise than in the illustrated case.

As also shown in FIG. 3B, in accordance with the invention slots 240a or 260a are disposed in front of through-holes 230 in the main direction of action HR of the weight load in reference to the respective through-holes 230, as a result of which through-holes 230 are particularly well or efficiently protected from the deformation forces.

Slots 240a, 250a, and 260a are again filled with an elastic and oil-resistant compound, such as nitrile rubber, in order to avoid the penetration of dirt and the escape of oil, for example.

The second embodiment of the invention is a particularly advantageous configuration from the viewpoint of production engineering and cost, because the production of the slots is less complex.

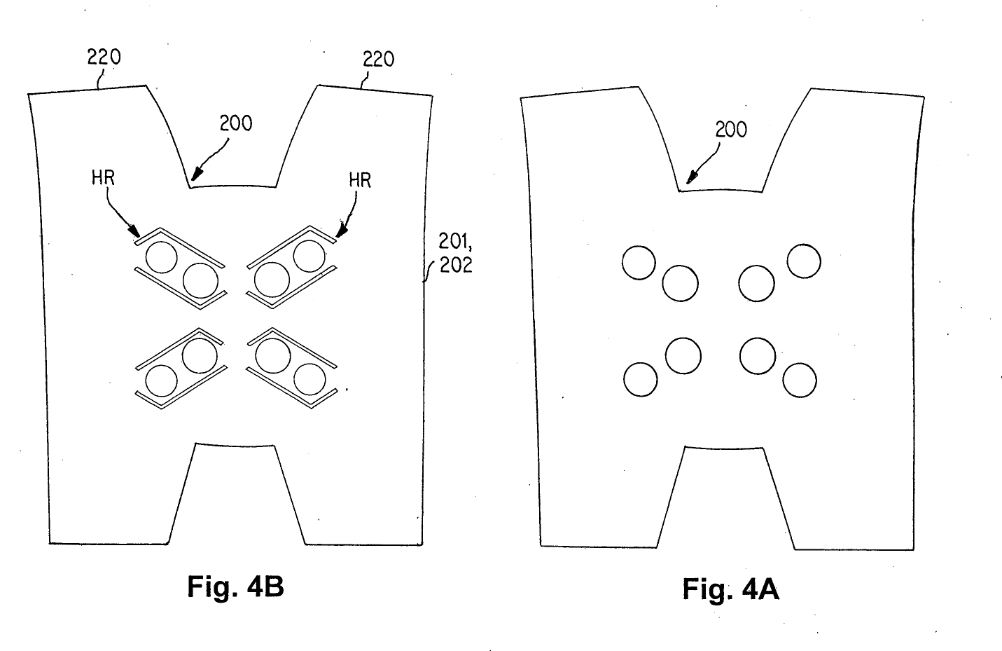

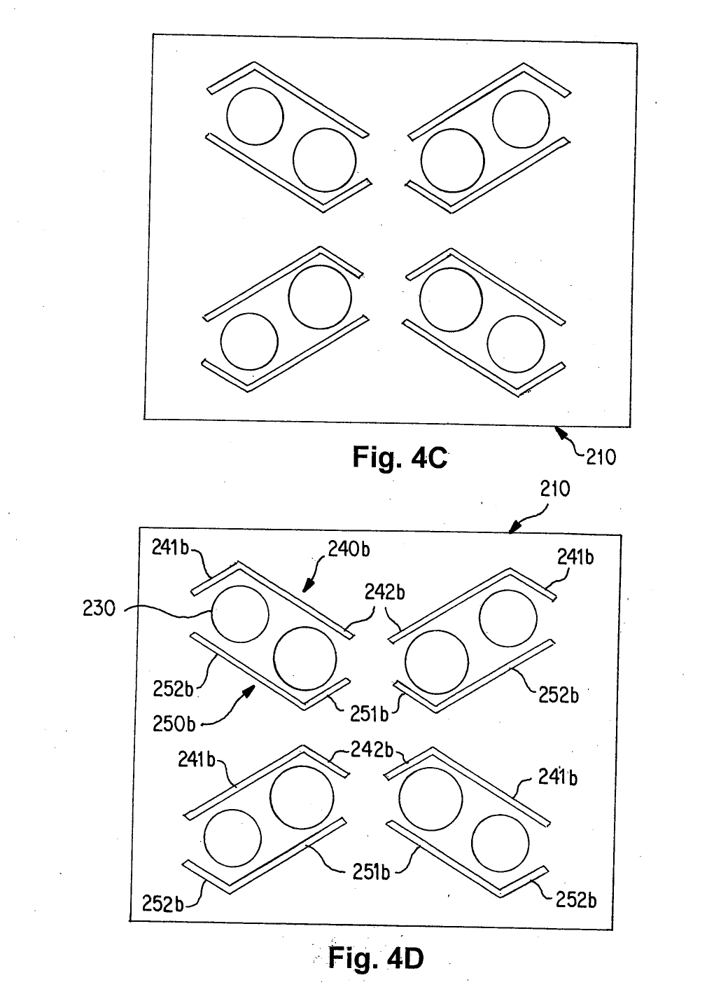

FIGS. 4A through 4D show a third embodiment of the invention which, with the exception of the configuration of the component-free openings, is identical to the first and second embodiments of the invention. Therefore, only the component-free openings are described in detail below, and the same reference numbers as in the first embodiment are used for identical elements.

For the FE analysis underlying FIGS. 4A through 4D, a weight load of 25 metric tons was again applied in the same manner as in FIGS. 1A through 1D, 2A through 2D, and 3A through 3D. In addition, lateral wall 201 or 202 was again assumed for the FE analysis to be a smooth lateral wall without ribbing.

As shown by arrow HR in FIG. 4B, the weight load in reference to through-holes 230 also exhibits in this case a main direction of action in which the greatest deformation forces would act on through-holes 230. Depending on the configuration of lateral wall 201, 202, on which for example ribbing can be provided, the main direction of action HR of the weight load can naturally run otherwise than in the illustrated case.

As can best be seen in FIG. 4D, in accordance with the third embodiment of the invention a slot 240b (first component-free opening) that runs through the thickness of assembly section 210, whose length is greater than the diameter of relevant through-hole 230 is provided in assembly section 210 between support section 220 and each through-hole 230. Moreover, in accordance with the second embodiment of the invention, a slot 250b (second component-free opening) that runs through the thickness of assembly section 210, whose length is greater than the diameter of relevant through-hole 230, is provided in assembly section 210 on the side of respective through-hole 230 opposite slot 240b.

As can be seen in FIGS. 4A through 4D, the weight load also leads to deformations in lateral wall 201 or 202 in this case, with the deformations approximately corresponding to those described in reference to FIGS. 1A through 1D.

As can be seen in particular in FIG. 4C and FIG. 4D, however, since a slot 240b whose length is at least as large as the diameter of relevant through-hole 230 is provided between support section 220 and each through-hole 230, through-holes 230 are protected from the deformation forces induced by the weight load or the deformation forces are diverted to adjacent sections of lateral wall 201 or 202, so that through-holes 230 are not deformed or are only minimally deformed and retain their original circular shape. As can be seen from FIGS. 4A through 4D, the weight load in this case also leads to deformations of lateral wall 201 or 202, and the deformations approximately correspond to those that were described in reference to FIGS. 1A through 1D.

Since in addition a slot 250b (second component-free openings), whose length is at least as large as the diameter of the relevant through-hole 230, is provided on the side of respective through-holes 230 opposite slots 240b (first component-free openings), through-holes 230 are also reliably protected from deformation forces or reaction forces acting on them from the other side or from below.

As also shown in FIG. 4B, in accordance with the invention slots 240b are disposed in front of through-holes 230 in the main direction of action HR of the weight load in reference to the respective through-holes 230, as a result of which through-holes 230 are particularly well or efficiently protected from the deformation forces.

Contrary to the first embodiment of the invention, slots 240b and 250b do not run horizontally but rather obliquely between the horizontal direction and the vertical direction. Moreover, a single slot 240b and a single slot 250b is always allocated respectively to two through-holes 230. This means that the pair of through-holes 230 shares both slots 240b and 250b. For that purpose, slots 240b, 250b have a length that is greater than the sum of the two diameters of the pair of through-holes 230 and their distance from each other.

In accordance with this embodiment of the invention, the width of the slots is 9 mm.

As can be seen in FIG. 4D, upper slot 240b of the pair of through-holes 230 has a first section 241b and a second section 242b disposed at an angle to it. Moreover, lower slot 250b of the pair of through-holes 230 has a first section 251b and a second section 252b disposed at an angle to it.

As can be seen in particular from FIG. 4B and FIG. 4D, slots 240b and 250b extend along their length at least in one section that is oblique to the main direction of action HR of the weight load. This means that, in accordance with the third embodiment of the invention, first sections 241b or 251b of slots 240b and 250b extend obliquely to the main direction of action HR. Second sections 242b or 252b of slots 240b and 250b extend at an obtuse angle to respective associated first section 241b, 251b.

As can also be seen from FIGS. 4A through 4D, in accordance with the third embodiment of the invention lower slot 250b of a pair of through-holes 230 is designed to be doubly mirror-inversed to upper slot 240b of the relevant pair of through-holes 230. In other words, lower slot 250b is mirrored over a mirror axis that runs between the two through-holes 230 and mirrored over a mirror axis that runs through the midpoint of the two through-holes 230.

As a result of this arrangement of slots 240b and 250b, through-holes 230 are even more effectively protected from deformation forces, since the pair of through-holes 230 is quasi or approximately surrounded by the slots. At the same time, as a result of the integration of slots (compared with the first and second embodiments) a solution that is advantageous with regard to production engineering is obtained since the two sections of a slot can be produced in one operational step, i.e., without withdrawing the milling cutter.

In that connection it must be noted that slots 240b and 250b in accordance with the third embodiment naturally can be produced with a length such that sufficient material thickness remains between the ends of slots 240b and 250b, in order to ensure reliable and stable bearing of the cylinder of the printing unit in through-holes 230. Moreover, slots 240b and 250b are again filled with an elastic and oil-resistant compound, such as nitrile rubber, in order to avoid the penetration of dirt and the escape of oil, for example.

To summarize, the placement of component-free openings or relief sections in accordance with the invention ensures that in a functional unit for a rotary printing press the pre-stresses induced by the weight load on bearing elements are inexpensively reduced or avoided for their components.

Premature failure of the bearing elements, such as ball bearings or roller bearings, is thus advantageously avoided.

### List of Reference Numbers

100 Assembly unit or base frame

101 Assembly unit element or lateral wall

102 Assembly unit element or lateral wall

110 Assembly section

120 Support section

130 Assembly opening or through-hole

200 Assembly unit or base frame

201 Assembly unit element or lateral wall

202 Assembly unit element or lateral wall

210 Assembly section

220 Support section

230 Assembly opening or through-hole

240 Component-free opening or slot

250 Component-free opening or slot

240a Component-free opening or slot

250a Component-free opening or slot

260a Component-free opening or slot

240b Component-free opening or slot

241b First section of slot 240b

242b Second section of slot 240b

250b Component-free opening or slot

251b First section of slot 250b

252b Second section of slot 250b

HR Main direction of action of the weight load

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A functional unit for a rotary printing press having an assembly unit which receives a component of the functional unit, in which the assembly unit has an assembly section having a pre-specified thickness, an assembly opening that is formed in the assembly section and in which the component is received by a bearing element, and a support section on which a weight load is supportable, wherein a first component-free opening that in a cross-sectional dimension is at least as large as a cross-sectional dimension of the assembly opening is provided in the assembly section between the support section and the assembly opening.

2. The functional unit according to claim 1, wherein the assembly opening is designed as a through-hole running through the thickness of the assembly section.

3. The functional unit according to claim 1, wherein the first component-free opening is designed as a through-hole running through the thickness of the assembly section.

4. The functional unit according to claim 1, wherein the first component-free opening is disposed in front of the assembly opening in a main direction of action of the weight load in reference to the assembly opening.

5. The functional unit according to claim 1, wherein the first component-free opening is designed as a slot having a pre-specified width and a pre-specified length.

6. The functional unit according to claim 5, wherein the first component-free opening designed as the slot extends in a linear fashion along a length, at least sectionally.

7. The functional unit according to claim 5, wherein the first component-free opening designed as the slot extends along a length obliquely to a main direction of action of the weight load at least in one section.

8. The functional unit according to claim 1, wherein a second component-free opening that in a cross-sectional dimension is at least as large as a cross-sectional dimension of the assembly opening is provided in the assembly section on a side of the assembly opening opposite the first component-free opening.

9. The functional unit according to claim 8, wherein the second component-free opening is designed as a through-hole running through the thickness of the assembly section.

10. The functional unit according to claim 8, wherein the second component-free opening is designed as a slot having a pre-specified width and a pre-specified length.

11. The functional unit according to claim 10, wherein the second component-free opening designed as the slot extends in a linear fashion along a length, at least sectionally.

12. The functional unit according to claim 11, wherein the second component-free opening designed as the slot extends along the length obliquely to a main direction of action of the weight load at least in one section.

13. The functional unit according to claim 8, wherein the second component-free opening is designed to be doubly mirror-inversed to the first component-free opening.

14. The functional unit according to claim 1, wherein the assembly opening is designed as a circular opening of pre-specified diameter.

15. The functional unit according to claim 1, wherein the assembly unit has at least two assembly unit elements.

16. The functional unit according to claim 15, wherein at least one assembly opening is formed in each of the assembly unit elements.

17. The functional unit according to claim 1, wherein the functional unit is a printing unit.

18. The functional unit according to claim 17, wherein the assembly unit is a lateral wall of the printing unit.

19. The functional unit according to claim 18, wherein the component is a cylinder of the printing unit which is rotatably borne by a bearing element in the assembly opening of the lateral wall of the printing unit.

20. A rotary printing press having a functional unit according to claim 1.
